(19) United States
(12) Patent Application Publication
(10) Pub. No.: US 2019/0287469 A1
(43) Pub. Date: Sep. 19, 2019

(54) DISPLAY DEVICE AND A METHOD FOR DRIVING THE SAME

(71) Applicant: SAMSUNG DISPLAY CO, LTD,, Yongin-Si (KR)

(72) Inventors: Youngmin PARK, Hwaseong-si (KR); Jieun NAM, Seoul (KR); Mansoo KIM, Asan-si (KR)

(21) Appl. No.: 16/292,503

(22) Filed: Mar. 5, 2019

(30) Foreign Application Priority Data
Mar. 13, 2018 (KR) 10-2018-0029077

(51) Int. Cl. G09G 3/36; G09G 3/34

(52) U.S. Cl. CPC G09G 3/3607; G09G 3/3688; G09G 3/3413; G09G 2320/0686; G09G 2310/08; G09G 2320/0242; G09G 2320/0646; G09G 3/342

(57) ABSTRACT

A display device including: a display panel having red, green and blue pixels; a backlight unit; a data driver; and a controller for applying red, green, and blue image data signals, wherein, when the red image data signal of a current frame has a magnitude different from a magnitude of the red image data signal of a previous frame, the controller applies a corrected image data signal having a magnitude different from the magnitude of the red image data signal of the current frame to the data driver as a red image of the current frame, and when the green image data signal of the current frame has a magnitude different from a magnitude of the green image data signal of the previous frame, the controller applies the green image data signal of the current frame to the data driver as a green image of the current frame.

### CROSS-REFERENCE TO RELATED APPLICATION

This application claims priority under 35 U.S.C. § 119 to Korean Patent Application No. 10-2018-0029077, filed on Mar. 13, 2018, in the Korean Intellectual Property Office (KIPO), the disclosure of which is incorporated by reference herein in its entirety.

### 1. Technical Field

Exemplary embodiments of the present invention relate to a display device, and more particularly, to a display device for providing a wide color gamut and a method for driving the display device.

### 2. Discussion of Related Art

Liquid crystal display (“LCD”) devices are one of most widely used types of flat panel display (“FPD”) devices. The LCD device includes two substrates on which electrodes are formed and a liquid crystal layer interposed between the substrates. The LCD device adjusts an amount of transmitted light by applying a voltage to the electrodes and rearranging liquid crystal molecules in the liquid crystal layer.

### SUMMARY

According to an exemplary embodiment of the present invention, a display device includes: a display panel including a red pixel, a green pixel and a blue pixel; a backlight unit for providing light to the display panel; a data driver connected to the display panel; and a timing controller for applying a red image data signal, a green image data signal, and a blue image data signal corresponding to the red pixel, the green pixel and the blue pixel, respectively, to the data driver. When the red image data signal of a current frame has a magnitude different from a magnitude of the red image data signal of a previous frame, the timing controller applies a corrected image data signal having a magnitude different from the magnitude of the red image data signal of the current frame to the data driver as a red image of the current frame. When the green image data signal of the current frame has a magnitude different from a magnitude of the green image data signal of the previous frame, the timing controller applies the green image data signal of the current frame to the data driver as a green image of the current frame. When the blue image data signal of the current frame has a magnitude different from a magnitude of the blue image data signal of the previous frame, the timing controller applies the blue image data signal of the current frame to the data driver as a blue image of the current frame.

When the magnitude of the red image data signal of the current frame is greater than the magnitude of the red image data signal of the previous frame, the magnitude of the corrected image data signal may be greater than the magnitude of the red image data signal of the current frame.

When the magnitude of the red image data signal of the current frame is less than the magnitude of the red image data signal of the previous frame, the magnitude of the corrected image data signal may be less than the magnitude of the red image data signal of the current frame.

The backlight unit may include: a light source for emitting the light; and a bottom case at which the light source is positioned.

The light source may include: a light emitting chip for emitting blue light; and red phosphors and green phosphors positioned on the light emitting chip

The red phosphor may have a persistence time longer than a persistence time of the green phosphor.

The red phosphor may have an excitation time longer than an excitation time of the green phosphor.

The red phosphor may include K₂SiF₆:Mn₄⁺.

The magnitude of the corrected image data signal may be determined based on: a magnitude difference between the red image data signal of the current frame and the red image data signal of the previous frame; a persistence time of the red phosphor; or a location of a display area of the display panel in which the red pixel is located.

The display device may further include a look-up table in which the magnitude difference between the red image data signal of the current frame and the red image data signal of the previous frame, the persistence time of the red phosphor, and the location of the display area of the display panel in which the red pixel is located are stored.

The backlight unit may include: a plurality of light sources including the light source; and a light guide plate having a plurality of light incidence surfaces facing the plurality of light sources, and a plurality of light emitting surfaces facing a plurality of display areas of the display panel.

The light guide plate may include a plurality of light guide blocks, and each light guide block may have one of the plurality of light incidence surfaces and one of the plurality of light emitting surfaces.

At least one of the light guide blocks may have a semicircular column shape.

The backlight unit may further include a plurality of light sources including the light source. The bottom case may have a plurality of light source areas facing a plurality of display areas of the display panel. The plurality of light sources may be located in the plurality of light source areas of the bottom case.

The timing controller may apply the corrected image data signal to the data driver during the current frame or a plurality of consecutive frames including the current frame.

According to an exemplary embodiment of the present invention, a method of driving a display device is provided. The display device includes a display panel, a backlight unit, a data driver and a timing controller, the display panel including a red pixel, a green pixel and a blue pixel. The method includes: providing, via the backlight unit, light to the display panel; applying, via the timing controller, a red image data signal, a green image data signal, and a blue image data signal corresponding to the red pixel, the green pixel and the blue pixel, respectively, to the data driver; applying a corrected image data signal having a magnitude different from the magnitude of the red image data signal of a current frame to the data driver as a red image of the current frame, when the red image data signal of the current frame has a magnitude different from a magnitude of the red image data signal of a previous frame; applying the green image data signal of the current frame to the data driver as a green image of the current frame, when the green image data signal of the current frame has a magnitude different from a magnitude of the green image data signal of a previous frame; and applying the blue image data signal of the current frame to the data driver as a blue image of the current frame, when the blue image data signal of the current frame has a magnitude different from a magnitude of the blue image data signal of a previous frame.

When the magnitude of the red image data signal of the current frame is greater than the magnitude of the red image data signal of the previous frame, the magnitude of the corrected image data signal may be greater than the magnitude of the red image data signal of the current frame. When the magnitude of the red image data signal of the current frame is less than the magnitude of the red image data signal of the previous frame, the magnitude of the corrected image data signal may be less than the magnitude of the red image data signal of the current frame.

A light source of the backlight unit may include: a light emitting chip for emitting blue light; and red phosphors and green phosphors positioned on the light emitting chip. The red phosphor may have a persistence time longer than a persistence time of the green phosphor and has an excitation time longer than an excitation time of the green phosphor.

The red phosphor may include K₂SiF₆:Mn₄⁺.

The magnitude of the corrected image data signal may be determined based on: a magnitude difference between the red image data signal of the current frame and the red image data signal of the previous frame; a persistence time of the red phosphor; or a location of a display area of the display panel in which the red pixel is located.

According to an exemplary embodiment of the present invention, there is provided a display device including: a display panel including a first pixel and a second pixel; a backlight unit for providing light to the display panel; a data driver connected to the display panel; and a timing controller for applying a first image data signal and a second image data signal corresponding to the first pixel and the second pixel, respectively, to the data driver, wherein, when the first image data signal of a current frame has a magnitude different from a magnitude of the first image data signal of a previous frame, the timing controller applies a corrected image data signal having a magnitude different from the magnitude of the first image data signal of the current frame to the data driver as a first image of the current frame, and when the second image data signal of the current frame has a magnitude different from a magnitude of the second image data signal of the previous frame, the timing controller applies the second image data signal of the current frame to the data driver as a second image of the current frame.

The first pixel is a red pixel and the second pixel is a green pixel or a blue pixel.

The first image data signal is a red image data signal and the second image data signal is a green image data signal or a blue image data signal.

The first image is a red image and the second image is a green image or a blue image.

### BRIEF DESCRIPTION OF THE DRAWINGS

The above and other features of the present invention will become more apparent by describing in detail exemplary embodiments thereof with reference to the accompanying drawings, wherein:

FIG. 1 is a view illustrating a display device according to an exemplary embodiment of the present invention;

FIG. 2 is a detailed view illustrating a display panel illustrated in FIG. 1, according to an exemplary embodiment of the present invention;

FIG. 3 is a cross-sectional view illustrating a light source included in a backlight of FIG. 1, according to an exemplary embodiment of the present invention;

FIG. 4 is a diagram showing spectral characteristic curves of red light, green light, and blue light generated from the light source of FIG. 3, according to an exemplary embodiment of the present invention;

FIGS. 5A and 5B are diagrams for explaining the excitation and afterglow characteristics of a KSF red phosphor, according to an exemplary embodiment of the present invention;

FIG. 6 is a perspective view illustrating the backlight and the display panel of FIG. 1, according to an exemplary embodiment of the present invention;

FIG. 7A is a view illustrating an image of an (n-1)-th frame displayed on the display panel of FIG. 6, according to an exemplary embodiment of the present invention;

FIG. 7B is a diagram for explaining the operation of the backlight according to the image of FIG. 7A, according to an exemplary embodiment of the present invention;

FIG. 8A is a view illustrating an image of an n-th frame displayed on the display panel of FIG. 6, according to an exemplary embodiment of the present invention;

FIG. 8B is a diagram for explaining the operation of the backlight according to the image of FIG. 8A, according to an exemplary embodiment of the present invention;

FIG. 9A is a diagram for explaining the operation of a timing controller of FIG. 1 when the magnitude of an image data signal increases, according to an exemplary embodiment of the present invention;

FIG. 9B is a diagram for explaining the operation of the timing controller of FIG. 1 when the magnitude of the image data signal decreases, according to an exemplary embodiment of the present invention;

FIG. 10 is a diagram showing a look-up table and the timing controller of FIG. 1, according to an exemplary embodiment of the present invention;

FIG. 11 is a detailed view illustrating a display device including a light guide plate of FIG. 6, according to an exemplary embodiment of the present invention; and

FIG. 12 is a perspective view illustrating a backlight and a display panel of FIG. 1 according to another exemplary embodiment of the present invention.

### DETAILED DESCRIPTION OF THE EMBODIMENTS

Exemplary embodiments of the present invention will now be described more fully hereinafter with reference to the accompanying drawings. The present invention may, however, be embodied in many different forms and should not be construed as being limited to the exemplary embodiments set forth herein.

In the drawings, thicknesses of a plurality of layers and areas may be illustrated in an enlarged manner for clarity and ease of description thereof. When a layer, area, or plate is referred to as being “on” another layer, area, or plate, it may be directly on the other layer, area, or plate, or intervening layers, areas, or plates may be present therebetween. In the drawings, like reference numerals may refer to like elements. In the drawings, like reference numerals may refer to like elements.

Throughout the specification, when an element is referred to as being “connected” to another element, the element may be “directly connected” to the other element, or “electrically connected” to the other element with one or more intervening elements interposed therebetween.

“About” or “approximately” as used herein may be inclusive of the stated value and means within an acceptable range of deviation for the particular value as determined by one of ordinary skill in the art, considering the measurement in question and the error associated with measurement of the particular quantity (e.g., the limitations of the measurement system). For example, “about” may mean within one or more standard deviations, or within ±30%, 20%, 80%, 5% of the stated value.

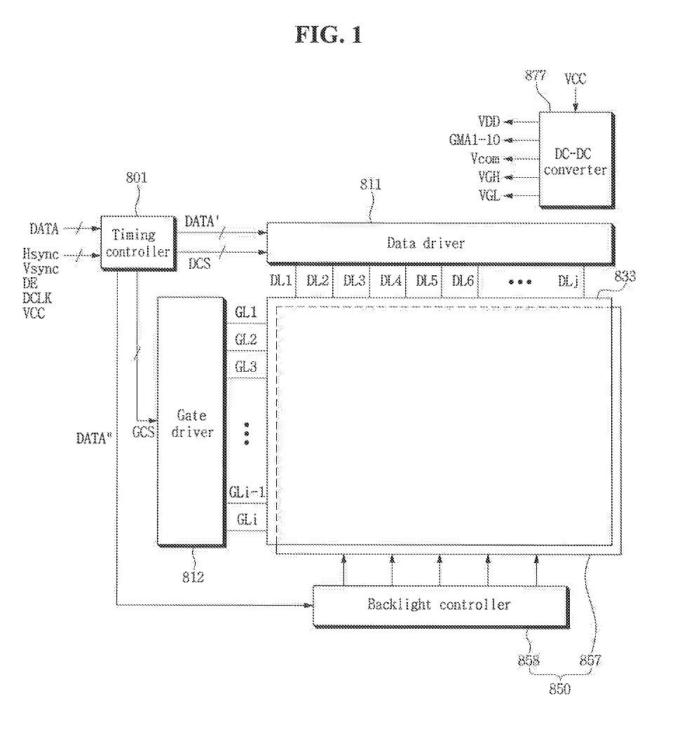

Hereinafter, a display device according to exemplary embodiments of the present invention will be described in detail with reference to FIGS. 1 to 12.

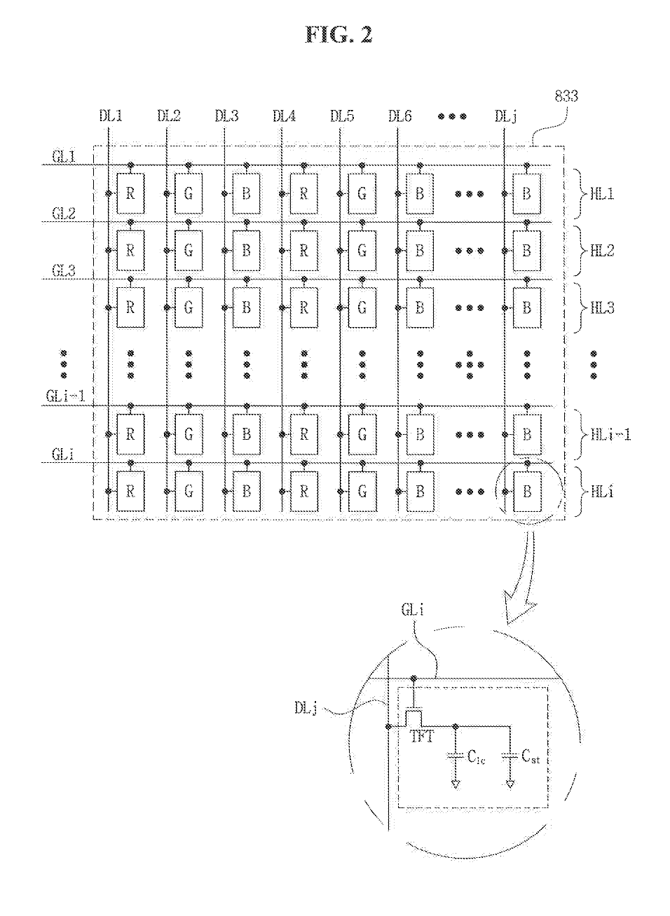

FIG. 1 is a view illustrating a display device according to an exemplary embodiment of the present invention, and FIG. 2 is a detailed view illustrating a display panel illustrated in FIG. 1, according to an exemplary embodiment of the present invention.

A display device includes a display panel 833, a backlight unit 850, a timing controller 801, a gate driver 812, a data driver 811, and a direct current (DC)-DC converter 877, as illustrated in FIG. 1. In an exemplary embodiment of the present invention, the backlight unit 850 includes a backlight 857 and a backlight controller 858.

The display panel 833 displays images. The display panel 833 includes, for example, a liquid crystal layer, and lower and upper substrates which face each other with the liquid crystal layer interposed therebetween.

A plurality of gate lines GL1 to GLi, a plurality of data lines DL1 to DLj crossing the gate lines GL1 to GLi, and a plurality of thin film transistors connected to the gate lines GL1 to GLi and the data lines DL1 to DLj are disposed at the lower substrate.

In addition, a black matrix, a plurality of color filters, and a common electrode are positioned at the upper substrate. The black matrix is located in a portion of the upper substrate excluding portions of the upper substrate corresponding to pixel areas. The color filters are located in the pixel areas. The color filters may include a red color filter, a green color filter, and a blue color filter.

In an exemplary embodiment of the present invention, the black matrix and the plurality of color filters described above may be positioned at the lower substrate rather than the upper substrate.

Pixels R, G, and B are arranged in a matrix form. The pixels R, G, and B may include red pixels R located in areas corresponding to the red color filters, green pixels G located in areas corresponding to the green color filters, and blue pixels B located in areas corresponding to the blue color filters. In an exemplary embodiment of the present invention, the red pixel R, the green pixel B and the blue pixel B that are adjacently disposed in a horizontal direction may be a unit pixel for displaying a unit image.

There are “j” number of pixels arranged along a p-th (p being one selected from 1 to i) horizontal line (hereinafter, p-th horizontal line pixels), which are individually connected to the first to j-th data lines DL1 to DLj, respectively. In addition, the p-th horizontal line pixels are connected in common to a p-th gate line. Accordingly, the p-th horizontal line pixels receive a p-th gate signal as a common signal. In other words, “j” number of pixels disposed in the same horizontal line all receive the same gate signal, while pixels disposed in different horizontal lines receive different gate signals. For example, the red pixel R, the green pixel G and the blue pixel B in a first horizontal line HL1 all receive a first gate signal, while the red pixel R, the green pixel G and the blue pixel B in a second horizontal line HL2 all receive a second gate signal that has an output timing which is different from an output timing of the first gate signal.

Each of the pixels R, G, and B includes a thin film transistor (“TFT”), a liquid crystal capacitor Clc, and a storage capacitor Cst, as illustrated in FIG. 2.

The TFT is turned on according to a gate signal applied from the gate line, e.g., GLi. The turned-on TFT applies analog image data signals applied from the data line, e.g., DLj, to the liquid crystal capacitor Clc and the storage capacitor Cst.

The liquid crystal capacitor Clc includes a pixel electrode and a common electrode which oppose each other.

The storage capacitor Cst includes a pixel electrode and an opposing electrode which oppose each other. Herein, the opposing electrode may be a previous gate line or a common line for transmitting a common voltage.

In an exemplary embodiment of the present invention, of the constituent elements of the pixels R, G and B, the TFT is covered by the black matrix.

The timing controller 801 receives a vertical synchronization signal Vsync, a horizontal synchronization signal Hsync, an image data signal DATA and a clock signal DCLK, which are output from a graphic controller provided in a system. An interface circuit may be provided between the timing controller 801 and the system, and the aforementioned signals output from the system are input to the timing controller 801 through the interface circuit. The interface circuit may be embedded in the timing controller 801.

The interface circuit may include a low voltage differential signaling (LVDS) receiver. The interface circuit lowers voltage levels of the vertical synchronization signal Vsync, the horizontal synchronization signal Hsync, the image data signal DATA and the clock signal DCLK output from the system, while raising frequencies thereof.

In an exemplary embodiment of the present invention, electromagnetic interference (“EMI”) may occur due to high frequency components of the signal input from the interface circuit to the timing controller 801. To prevent the EMI, an EMI filter may be further provided between the interface circuit and the timing controller 801.

The timing controller 801 generates a gate control signal GCS for controlling the gate driver 812 and a data control signal DCS for controlling the data driver 811, using the vertical synchronization signal Vsync, the horizontal synchronization signal Hsync and the clock signal DCLK.

The gate control signal GCS includes a gate start pulse, a gate shift clock, a gate output enable signal, or the like.

The data control signal DCS includes a source start pulse, a source shift clock, a source output enable signal, a polarity signal, or the like.

In addition, the timing controller 801 rearranges the image data signals DATA input through the system, and applies the rearranged image data signals DATA′ to the data driver 811. The image data signals DATA′ may include corrected image data signals to be described below.

In addition, the timing controller 801 rearranges the image data signals DATA input through the system, and applies the rearranged image data signals DATA″ to the backlight controller 858. The image data signals DATA″ do not include corrected image data signals to be described below.

In an exemplary embodiment of the present invention, the timing controller 801 is driven by a driving power VCC output from a power unit provided in the system. For example, the driving power VCC is used as a power voltage of a phase lock loop (“PLL”) circuit embedded in the timing controller 801. The PLL circuit compares the clock signal DCLK input to the timing controller 801 with a reference frequency generated by an oscillator. Thereafter, when it is determined from the comparison that there is a difference between the clock signal DCLK and the reference frequency, the PPL circuit adjusts the frequency of the clock signal DCLK by the difference to generate a sampling clock signal. This sampling clock signal is a signal for sampling the image data signals DATA′.

The DC-DC converter 877 increases or decreases the driving power VCC input through the system to generate various voltages required for the display panel 833. To accomplish this, the DC-DC converter 877 may include, for example, an output switching element for switching an output voltage of an output terminal of the DC-DC converter 877 and a pulse width modulator PWM for adjusting a duty ratio or a frequency of a control signal applied to a control terminal of the output switching element to increase or decrease the output voltage. Herein, the DC-DC converter 877 may include a pulse frequency modulator PFM, instead of the pulse width modulator PWM.

The pulse width modulator PWM may increase the duty ratio of the aforementioned control signal to raise the output voltage of the DC-DC converter 877 or decrease the duty ratio of the control signal to lower the output voltage of the DC-DC converter 877. The pulse frequency modulator PFM may increase the frequency of the aforementioned control signal to raise the output voltage of the DC-DC converter 877 or decrease the frequency of the control signal to lower the output voltage of the DC-DC converter 877. The output voltage of the DC-DC converter 877 may include a reference voltage VDD of about 6 [V] or more, a gamma reference voltage GMA1-10 less than level 10, a common voltage Vcom in a range from about 2.5 [V] to about 3.3 [V], a gate high voltage VGH of about 15 [V] or more, and a gate low voltage VGL of about −4 [V] or less.

The gamma reference voltage GMA1-10 is a voltage generated by voltage division of the reference voltage VDD. The reference voltage VDD and the gamma reference voltage GMA1-10 are analog gamma voltages, and they are provided to data driving integrated circuits (“ICs”) D-IC. The common voltage Vcom is applied to the common electrode of the display panel 833 via the data driving IC D-IC. The gate high voltage VGH is a high logic voltage of the gate signal that is set to be substantially equal to or higher than a threshold voltage of the TFT, and the gate low voltage VGL is a low logic voltage of the gate signal that is set to be an off-voltage of the TFT. The gate high voltage VGH and the gate low voltage VGL are applied to the gate driver 812.

The gate driver 812 generates gate signals according to the gate control signal GCS applied from the timing controller 801, and sequentially applies the gate signals to the plurality of gate lines GL1 to GLi. The gate driver 812, for example, may include a shift register that shifts the gate start pulse according to the gate shift clock and generates the gate signals. The shift register may include a plurality of switching elements. The switching elements may be formed on the lower substrate in the same process used to form the TFT located in a display portion of the display panel 833.

The data driver 811 receives the image data signals DATA′ and the data control signal DCS from the timing controller 801. The data driver 811 samples the image data signals DATA′ according to the data control signal DCS, latches the sampled image data signals corresponding to one horizontal line each horizontal period, and applies the latched data voltages to the data lines DL1 to DLj. In other words, the data driver 811 converts the image data signals DATA′ applied from the timing controller 801 into analog image data signals using the gamma reference voltages GMA1-10 input from the first DC-DC converter 877, and applies the converted analog image data signals to the data lines DL1 to DLj.

The backlight unit 850 provides light to the display panel 833. The backlight unit 850 includes the backlight 857 that emits light, and the backlight controller 858 that controls the backlight 857.

The backlight 857 includes at least one light source.

The backlight controller 858 controls the luminance of the light source based on the image data signal DATA″ applied from the timing controller 801. This image data signal DATA″ is an image data signal of one frame, and this image data signal does not include the corrected image data signal to be described below.

When the backlight 857 includes a plurality of light sources, the backlight controller 858 analyzes the image data signal of one frame to detect a bright display area and a dark display area from predetermined display areas of the display panel 833. The backlight controller 858 may realize dynamic images by increasing the luminance of the light source (or light sources) located in the bright display area and reducing the luminance of the light source (or light sources) located in the dark display area.

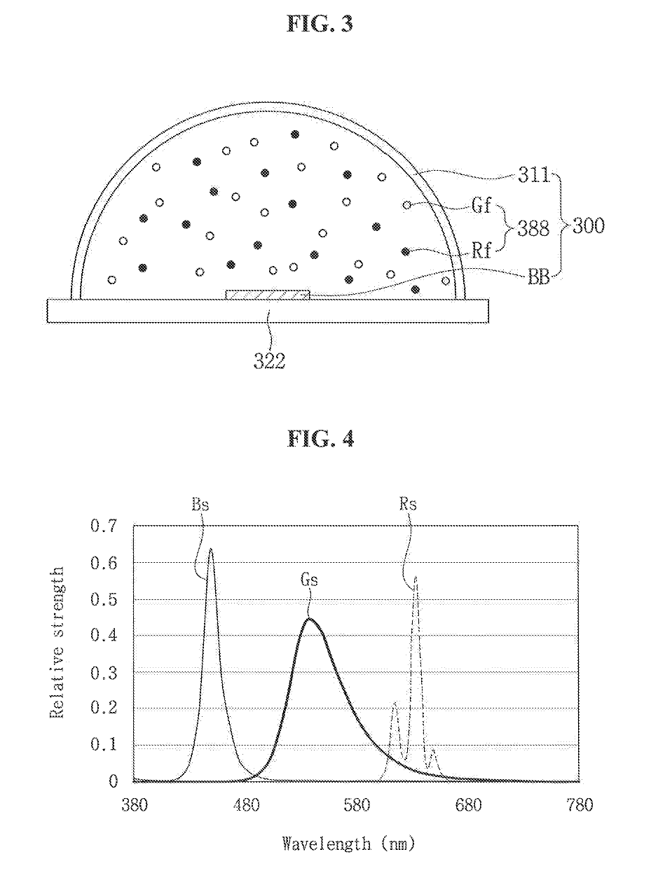

FIG. 3 is a cross-sectional view illustrating a light source included in a backlight of FIG. 1, according to an exemplary embodiment of the present invention.

A light source 300 may include a light emitting chip BB, a phosphor (e.g., a fluorescent element) 388, and a cover 311, as illustrated in FIG. 3. For example, the light source 300 may be a light emitting package including the light emitting chip BB, the phosphor 388, and the cover 311.

The light emitting chip BB emits light. For example, the light emitting chip BB includes a light emitting element that emits blue light. The light emitting element may be a light emitting diode (“LED”).

The phosphor 388 is positioned on the light emitting chip BB. The phosphor 388 surrounds the light emitting chip BB. The phosphor 388 includes a red phosphor Rf and a green phosphor Gf. The red phosphor Rf and the green phosphor Gf may exist in a mixed state in the phosphor 388. The light source 300 having such a configuration emits white light.

The cover 311 is positioned on the phosphor 388. The cover 311 surrounds the phosphor 388. The cover 311 may have a hemispherical lens shape to have a wide beam angle. The cover 311 may include a silicone resin, an epoxy resin, or the like.

The blue light that is emitted from the light emitting chip BB and passes through the red phosphor Rf is converted into red light, and the blue light that is emitted from the light emitting chip BB and passes through the green phosphor Gf is converted into green light. The blue light from the light emitting chip BB, the red light from the red phosphor Rf, and the green light from the green phosphor Gf are mixed to produce white light. In other words, the light source 300 emits white light.

The light source 300 is driven by the driving power to emit light (e.g., white light). The light source 300 is installed at a printed circuit board 322.

On one side of the printed circuit board 322 at least one mounting and a wiring area may be located. When two or more light sources 300 are provided, one light source may be mounted on each mounting area, and a plurality of signal transmission lines for transmitting the driving power to the light sources 300 are installed in the wiring area. The above-described driving power is generated in an external power supply, and then, applied to the plurality of signal transmission lines via a separate connector. The printed circuit board 322 may include a metal material so that heat generated from the light source 300 may be transmitted to the outside.

FIG. 4 is a diagram showing spectral characteristic curves of red light, green light, and blue light generated from the light source of FIG. 3, according to an exemplary embodiment of the present invention.

The X-axis of FIG. 4 represents the wavelength, and the Y-axis of FIG. 4 represents the relative intensity.

FIG. 4 shows a spectral characteristic curve Bs of the blue light generated by the light emitting chip BB, a spectral characteristic curve Gs of the green light (e.g., green excitation light) generated by excitation of the green phosphor Gf, and a spectral characteristic curve Rs of the red light (e.g., red excitation light) generated by excitation of the red phosphor Rf.

The red phosphor Rf may be a red phosphor Rf including, for example, K₂SiF₆:Mn₄⁺ (“KSF”).

The red light generated by the red phosphor Rf including KSF (hereinafter, “a KSF red phosphor”) has a small wavelength range. Accordingly, dissimilar to the phosphor including RGs or RGn, the KSF red phosphor Rf has spectral characteristics of a sharp shape as in FIG. 4, which has a great intensity over a small wavelength range. Accordingly, when the KSF red phosphor Rf is used as the red phosphor, the amount of light in the overlap wavelength area (e.g., the mixed light of red light and green light) in which the wavelength area of red light overlaps the wavelength area of green light overlaps may be substantially minimized. Accordingly, when the KSF red phosphor Rf is used, a display device can provide a wide color gamut.

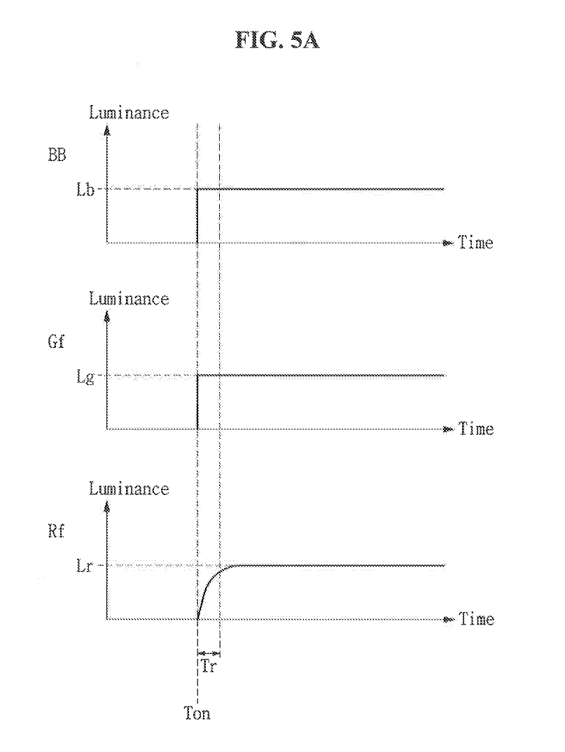

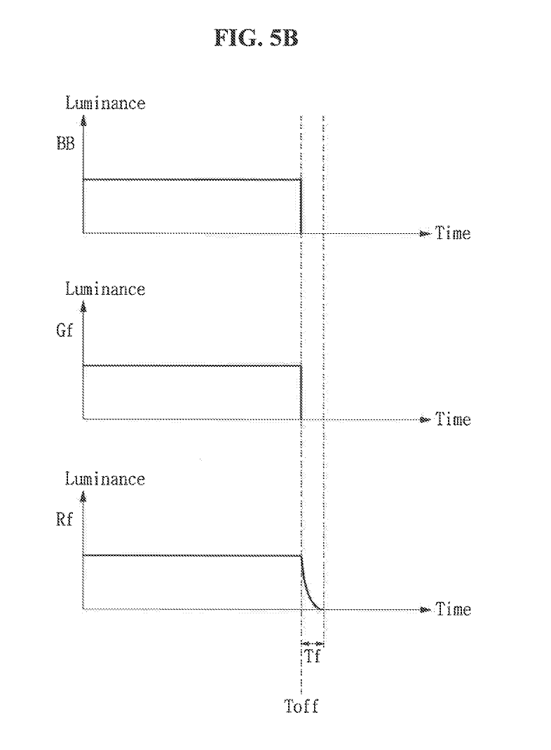

FIGS. 5A and 5B are diagrams for explaining the excitation and afterglow characteristics of a KSF red phosphor, according to an exemplary embodiment of the present invention.

Each X-axis in FIGS. 5A and 5B represents time (or a frame), and each Y-axis in FIGS. 5A and 5B represents the luminance of light.

As illustrated in FIG. 5A, the driving power is input to the light emitting chip BB in accordance with the turn-on time point Ton of the display device. Then, blue light is emitted from the light emitting chip BB by the driving power. The blue light reaches a target luminance Lb of the blue light at the turn-on time point Ton of the display device substantially without delay.

In addition, the green light generated by the green phosphor Gf at the turn-on time point Ton of the display device described above may reach a target luminance Lg of the blue light substantially at the turn-on time point Ton of the display device.

On the other hand, the KSF red phosphor Rf has an excitation time longer than that of general phosphors. For example, the KSF red phosphor Rf has an excitation time longer than that of the green phosphor Gf. Accordingly, the time required for the light generated by the KSF red phosphor Rf to reach a target luminance Lr is longer than that of the general phosphor (e.g., the green phosphor Gf).

Accordingly, the red light generated by the KSF red phosphor Rf at the turn-on time point Ton of the display device may not reach its target luminance Lr at the turn-on time point Ton. For example, the target luminance Lr may be reached at a certain period of time after the turn-on time point Ton. In other words, the red light from the KSF red phosphor Rf reaches the target luminance Lr later than the turn-on time point Ton of the display device.

Accordingly, at the turn-on time point Ton of the display device, the blue light and the green light respectively substantially reach the target luminances Lb and Lg, but the red light may not reach the target luminance Lr. Accordingly, during a transient period Tr from the turn-on time point Ton until the red light reaches the target luminance Lr, light of a color other than white light, e.g., cyan light, may be generated from the light source 300.

As illustrated in FIG. 5B, the driving power is shut off in accordance with a turn-off time point Toff of the display device. Then, the blue light is not generated by the light emitting chip BB due to the interruption of the driving power. The blue light reaches a target luminance, in other words, the luminance of zero, at the turn-off time point Toff of the display device substantially without delay. In other words, the blue light is substantially completely extinguished at the turn-off time point Toff of the display device.

In addition, the green light generated at the turn-off time point Toff by the green phosphor Gf of the display device may reach the target luminance, in other words, the luminance of zero, at the turn-off time point Toff.

On the other hand, the KSF red phosphor Rf has a persistence time (e.g., afterglow time) longer than that of the general phosphor. For example, the KSF red phosphor Rf has a persistence time longer than that of the green phosphor Gf. Accordingly, the red light from the KSF red phosphor Rf may not reach the luminance of zero at the turn-off time point Toff of the display device. For example, the luminance of zero may be reached at a certain period of time after the turn-off time point Toff. In other words, the red light from the KSF red phosphor Rf is extinguished later than the turn-on time point Ton of the display device.

Accordingly, while each of the blue light and the green light is extinguished at the turn-off time point Toff of the display device, the red light is not yet turned off and maintains the turn-on state. Accordingly, only the red light is generated from the light source 300 during a transient period Tf from the turn-off time point Toff until the red light is extinguished. Accordingly, even though the screen is turned off, a red color may be maintained on the screen for a while.

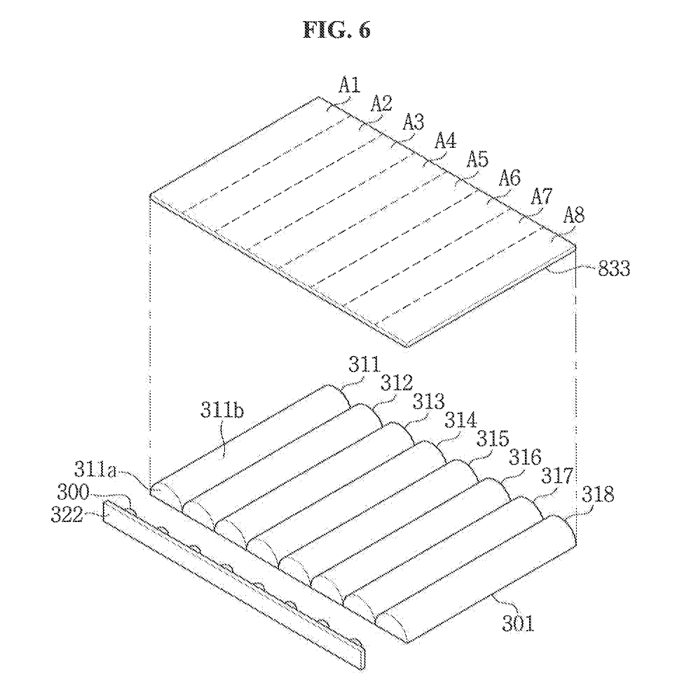

FIG. 6 is a perspective view illustrating the backlight and the display panel of FIG. 1, according to an exemplary embodiment of the present invention.

The backlight 857 may include the plurality of light sources 300, the printed circuit board 322, and a light guide plate 301, as illustrated in FIG. 6.

The display panel 833 includes a plurality of display areas A1 to A8. For example, the display panel 833 has a display portion and a non-display portion surrounding the display portion, and the display portion may include the plurality of display areas A1 to A8. The plurality of display areas A1 to A8 are located in the display portion. The plurality of display areas A1 to A8 are arranged in a line along one side of the display panel 833.

As illustrated in FIG. 6, the light guide plate 301 has a plurality of light incidence surfaces 311a facing the plurality of light sources 300 and a plurality of light emitting surfaces 311b facing the plurality of display areas A1 to A8 of the display panel 833.

The light guide plate 301 may have a plurality of light guide blocks 311 to 318, as illustrated in FIG. 6. The light guide blocks 311 to 318 are located to correspond to the display areas A1 to A8 of the display panel 833, respectively. In other words, the light guide blocks 311 to 318 face the display areas A1 to A8, respectively. For example, there are eight light guide blocks 311 to 318 (e.g., first to eighth light guide blocks) and eight display areas A1 to A8 (e.g., first to eighth display areas) in FIG. 6, and a k-th light guide block faces a k-th display area.

Each of the light guide blocks 311 to 318 may have a semi-circular column shape, as illustrated in FIG. 6. In such an embodiment, respective convex portions of the light guide blocks 311 to 318 face the display panel 833. Each of the light guide blocks 311 to 318 may have the shape of a lenticular lens having an elliptical cross-section.

The plurality of light sources 300 are positioned on the light incidence surface 311a of the light guide plate 301. The plurality of light sources 300 face the light incidence surface 311a of the light guide plate 301. The light incidence surface 311a corresponds to one surface of each of the light guide blocks 311 to 318. The one surface of each of the light guide blocks 311 to 318 may be a surface that faces a one respective one of the light sources 300. For example, there are eight light guide blocks 311 to 318 (e.g., first to eighth light guide blocks) and eight light sources 300 (e.g., first to eighth light sources) in FIG. 6, and a k-th light source faces a light incidence surface of the k-th light guide block.

In FIG. 6, one light source 300 is disposed for each light guide block 311 to 318. Alternatively, a plurality of light sources 300 may be disposed for each light guide block 311 to 318. In other words, at least two light sources 300 may face a light incidence surface 311a of one light guide block, e.g., the first light guide block 311.

Light sources that face different light guide blocks are connected to different power lines from each other. For example, a light source (hereinafter, “a first light source”) facing the light incidence surface 311a of the first light guide block 311 and a light source (hereinafter, “a second light source”) facing the light incidence surface of the second light guide block 312 are connected to different power lines from each other. In other words, the first light source may be connected to a first power line, and the second light source may be connected to a second power line.

In addition, when there are two or more light sources facing a light incidence surface of one light guide block, the plurality of light sources facing the light incidence surface of the one light guide block are connected in common to a same power line.

Since the light sources facing different light guide blocks are connected to different power lines, the light sources facing different light guide blocks may receive driving powers of different magnitudes through the power lines, respectively. Accordingly, the light sources facing different light guide blocks may emit light having different luminances from each other. Accordingly, it is possible to perform a local dimming operation in which the luminance of light may be controlled for each light guide block.

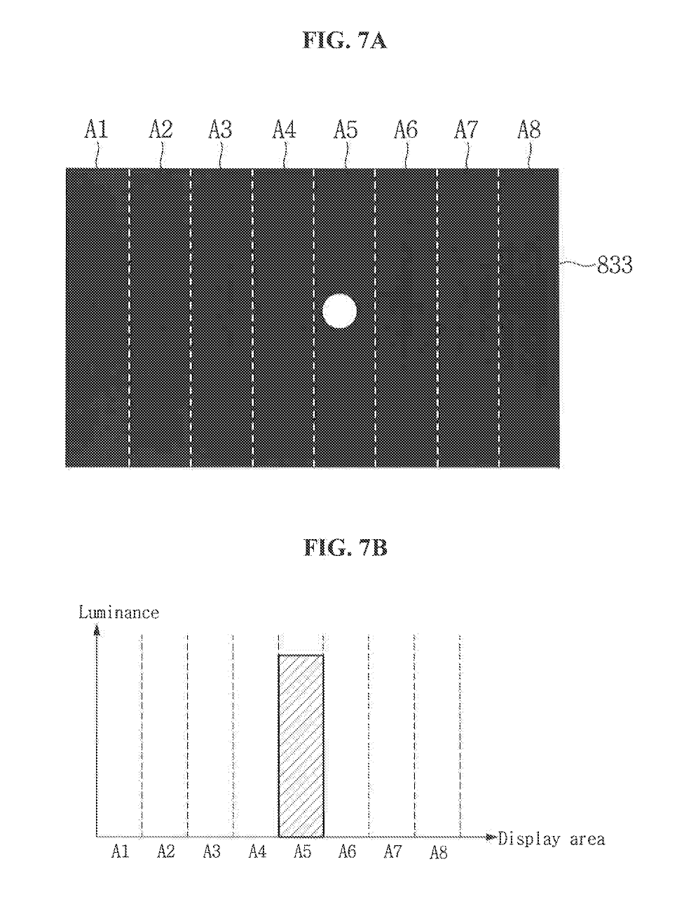

FIG. 7A is a view illustrating an image of an (n-1)-th frame displayed on the display panel of FIG. 6, according to an exemplary embodiment of the present invention, and FIG. 7B is a diagram for explaining the operation of the backlight according to the image of FIG. 7A, according to an exemplary embodiment of the present invention. In FIGS. 7A and 7B, n is a natural number greater than one.

The X-axis of 7B shows the location of the display area, and the Y-axis of FIG. 7B shows the luminance of the light sources provided in the backlight.

As illustrated in FIG. 7A, the fifth display area A5 of the display panel 833 displays an image of the moon with a dark night sky as background. In addition, the remaining display areas except for the fifth display area A5, e.g., the first, second, third, fourth, sixth, seventh and eighth display areas A1, A2, A3, A4, A6, and A7, display only the dark night background as the image. Accordingly, the image displayed in the fifth display area A5 of the first to eighth display areas A1 to A8 in FIG. 7A has a highest luminance. Each image displayed in the first, second, third, fourth, sixth, seventh and eighth display areas A1, A2, A3, A4, A6, A7 and A8 has a luminance less than the luminance of the image displayed in the fifth display area A5. In addition, each image displayed in the first, second, third, fourth, sixth, seventh and eighth display areas A1, A2, A3, A4, A6, A7 and A8 has a substantially equal luminance.

To improve the contrast ratio of the image of FIG. 7A, as illustrated in FIG. 7B, the fifth light guide block 315 corresponding to the fifth display area A5 emits light of a luminance higher than that of the other light guide blocks 311, 312, 313, 314, 316, 317, and 318. To achieve this, the fifth light source facing the light incidence surface of the fifth light guide block 315 emits light having a luminance higher than that of the other light sources. Accordingly, as illustrated in FIG. 7B, the light provided to the fifth display area A5 has a luminance higher than that of the light provided to the other display areas A1, A2, A3, A4, A6, A7, and A8.

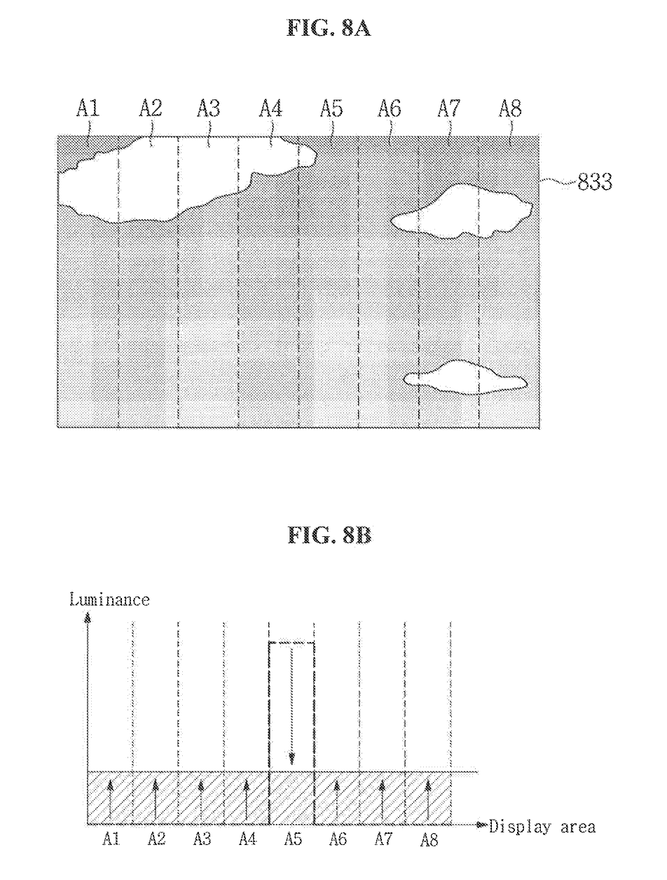

FIG. 8A is a view illustrating an image of an n-th frame displayed on the display panel of FIG. 6, according to an exemplary embodiment of the present invention, and FIG. 8B is a diagram for explaining the operation of the backlight according to the image of FIG. 8A, according to an exemplary embodiment of the present invention.

The X-axis of FIG. 8B shows the location of the display area, and the Y-axis of FIG. 8B shows the luminance of the light sources provided in the backlight.

As illustrated in FIG. 8A, in the first to eighth display areas A1 to A8 of the display panel 833, an image of a bright sky in daytime is displayed. Each of the images of the first to eighth display areas A1 to A8 in FIG. 8A have substantially equal luminance.

The image of FIG. 8A is displayed immediately after the image of FIG. 7A.

As the image of the display panel 833 is switched from the image of FIG. 7A to the image of FIG. 8A, the backlight 857 operates in accordance with the converted image. For example, as illustrated in FIG. 8B, the luminance of the light source corresponding to the fifth display area A5 decreases. In addition, the luminance of the light sources corresponding to the first, second, third, fourth, sixth, seventh and eighth display areas A1, A2, A3, A4, A6, A7 and A8 increases. The arrows in FIG. 8B indicate an increase or a decrease in luminance. For example, the arrow in the fifth display area A5 means that the luminance in the fifth display area

A5 decreases, and the arrows in the first, second, third, fourth, sixth, seventh and eighth display areas A1, A2, A3, A4, A6, A7 and A8 mean that the luminances in the first, second, third, fourth, sixth, seventh and eighth display areas A1, A2, A3, A4, A6, A7 and A8 increase.

In an exemplary embodiment of the present invention, due to the long excitation time characteristics of the KSF red phosphor Rf described above, the light provided to the first, second, third, fourth, sixth, seventh and eighth areas A1, A2, A3, A4, A6, A7, and A8 may have a color of, e.g., cyan, during the transient period Tr described above. In addition, due to the long persistence time characteristics of the KSF red phosphor Rf described above, the light provided to the fifth area A5 may have a color of, e.g., red, during the transient period Tf described above.

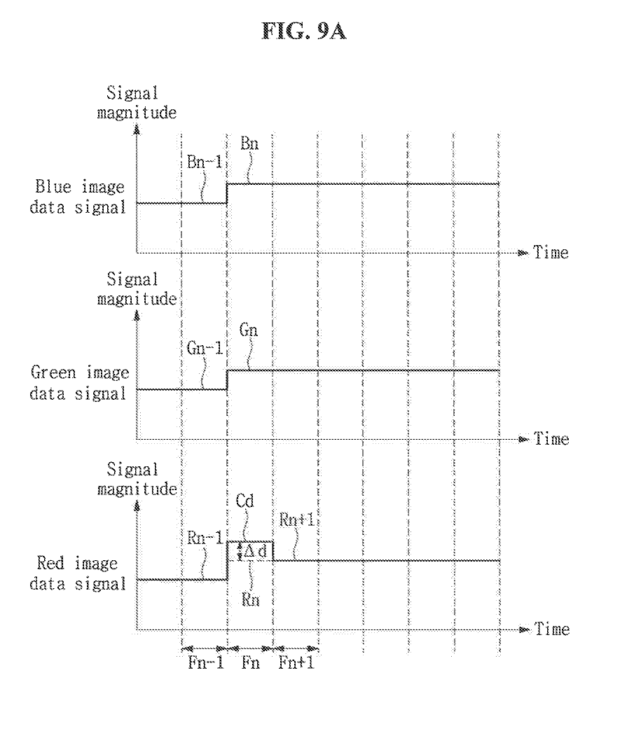

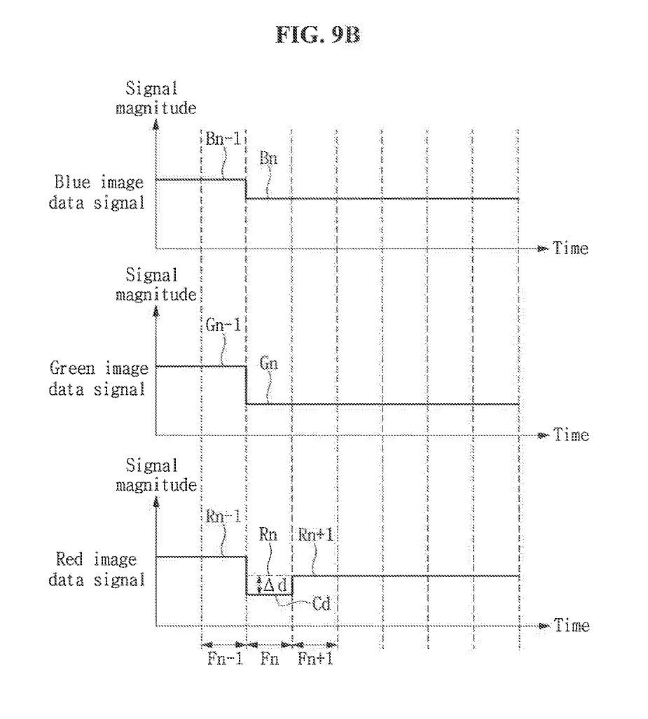

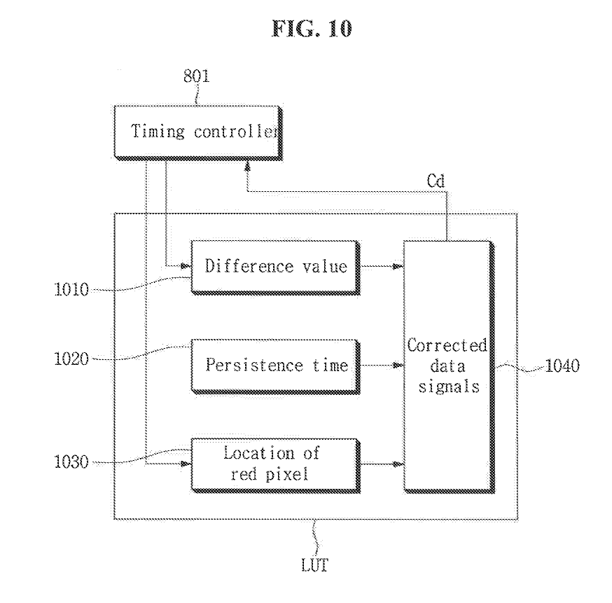

FIG. 9A is a diagram for explaining the operation of a timing controller of FIG. 1 when the magnitude of an image data signal increases, according to an exemplary embodiment of the present invention.

Each X-axis in FIG. 9A represents a frame (or time), and the Y-axis in FIG. 9A represents the magnitude of the image data signal (in other words, the grayscale of the image data signal).

The timing controller 801 receives a red image data signal, a green image data signal, and a blue image data signal from the outside (e.g., the system). The red image data signal corresponds to the red pixel R, the green image data signal corresponds to the green pixel G, and the blue image data signal corresponds to the blue pixel B. In other words, the red image data signal is applied to the red pixel R, the green image data signal is applied to the green pixel G, and the blue image data signal is applied to the blue pixel B.

Each of the red image data signal, the green image data signal, and the blue image data signal output from the timing controller 801 is a digital signal, and the red image data signal, the green image data signal, and the blue image data signal are applied from the timing controller 801 to the data driver 811. The data driver 811 converts the red image data signal, the green image data signal, and the blue image data signal into analog signals by using the above-described gamma voltages, and applies the red, green, and blue image data signals that have been converted into the analog signals to the red pixel R, the green pixel G and the blue pixel B, respectively. In other words, the red image data signal of the analog-converted signals is applied to the red pixel R, the green image data signal of the analog-converted signals is applied to the green pixel G, and the blue image data signal of the analog-converted signals is applied to the blue pixel B. The red image data signal, the green image data signal, and the blue image data signal that have been converted into the analog signals and output from the data driver 811 are applied to corresponding pixels through corresponding data lines.

The timing controller 801 applies the image data signals (e.g., DATA′) of one frame to the data driver 811. For example, the image data signals DATA′ of one frame include the red image data signal, the green image data signal, and the blue image data signal described above.

The timing controller 801 compares the image data signal of a current frame with the image data signal of a previous frame, before applying the image data signal of the current frame to the data driver 811. For example, the timing controller 801 compares the red image data signal of the current frame with the red image data signal of the previous frame, and determines whether the red image data signal of the current frame is the same as the red image data signal of the previous frame. If it is determined from the comparison that the red image data signal of the current frame is different from the red image data signal of the previous frame, the timing controller 801 applies a preset corrected image data signal, instead of the red image data signal of the current frame, to the data driver 811. In other words, the timing controller 801 outputs the corrected image data signal, which is not the red image data signal of the current frame, as a red image of the current frame, and applies the corrected image data signal to the data driver 811.

The corrected image data signal is a signal having a magnitude (e.g., gray level) different from that of the red image data signal of the current frame. For example, when the red image data signal of the current frame has a value greater than that of the red image data signal of the previous frame, the corrected image data signal has a value greater than that of the red image data signal of the current frame. In other words, when the red image data signal of the current frame has a value greater than that of the red image data signal of the previous frame, the timing controller 801 selects, as the red image of the current frame, the corrected image data signal that has a value greater than that of the red image data signal of the current frame.

For example, as illustrated in FIG. 9A, when a red image data signal Rn (indicated by a dashed line) of an n-th frame Fn has a value greater than that of a red image data signal Rn-1 of an (n-1)-th frame Fn-1, the timing controller 801 selects, as the red image of the n-th frame Fn, a corrected image data signal Cd that has a value greater than that of the red image data signal Rn of the n-th frame Fn, instead of selecting the red image data signal Rn of the n-th frame Fn, and applies the corrected image data signal Cd to the data driver 811. In other words, as illustrated in FIG. 9A, the timing controller 801 outputs the corrected image data signal Cd, instead of the red image data signal Rn of the n-th frame Fn, as the red image of the n-th frame Fn.

In an exemplary embodiment of the present invention, after the corrected image data signal Cd is output, the timing controller 801 may select, as a red image of a succeeding frame, the red image data signal of the current frame or a red image data signal having a value substantially equal to that of the red image data signal of the current frame, and may apply the selected red image data signal to the data driver 811. For example, as illustrated in FIG. 9A, a red image data signal Rn+1 of an (n+1)-th frame Fn+1 provided from the timing controller 801 may have a value substantially equal to the value of the red image data signal of the n-th frame Fn.

In another exemplary embodiment of the present invention, the aforementioned correction image data signal Cd may be selected as the red image of the succeeding frame. In other words, the corrected image data signal Cd may be selected for a plurality of consecutive frames including the current frame. For example, the red image data signal Rn+1 of the (n+1)-th frame Fn+1 in FIG. 9A may have a value substantially equal to the value of the corrected image data signal Cd.

In addition, when the green image data signal of the current frame is different from the green image data signal of the previous frame, the timing controller 801 selects the green image data signal of the current frame as the green image of the current frame, and applies the selected green image data signal of the current frame to the data driver 811. For example, as illustrated in FIG. 9A, when the green image data signal Gn of the n-th frame Fn has a value greater than that of the green image data signal Gn-1 of the previous frame Fn-1, the timing controller 801 selects the green image data signal Gn of the n-th frame Fn as the green image of the current frame, and applies the selected green image data signal Gn of the n-th frame Fn to the data driver 811.

In other words, the timing controller 801 selects the green image data signal of the current frame as the green image of the current frame regardless of the magnitude change of the green image data signal.

In addition, when the blue image data signal of the current frame is different from the blue image data signal of the previous frame, the timing controller 801 selects the blue image data signal of the current frame as the blue image of the current frame, and applies the selected blue image data signal of the current frame to the data driver 811. For example, as illustrated in FIG. 9A, when the blue image data signal Bn of the n-th frame Fn has a value greater than that of the blue image data signal Bn-1 of the previous frame Fn-1, the timing controller 801 selects the blue image data signal Bn of the n-th frame Fn as the blue image of the current frame, and applies the selected blue image data signal Bn of the n-th frame Fn to the data driver 811.

In other words, the timing controller 801 selects the blue image data signal of the current frame as the blue image of the current frame regardless of the magnitude change of the blue image data signal.

In this way, of the red, green, and blue image data signals, the timing controller 801 over-drives only the red image data signal in a selective manner. Accordingly, the red pixel R receiving the over-driven red image data signal may transmit a larger amount of light as compared to the gray level of the current frame.

For example, when the gray level of the red image data signal applied to the red pixel R increases from a first gray level to a second gray level, the light transmittance of the red pixel R in the current frame becomes higher than the light transmittance of the second gray level.

Accordingly, when the red pixel R, the green pixel G and the blue pixel B all display the same gray scale image in the current frame, the amount of light passing through the red pixel R increases, as compared to the amount of light passing through the green pixel G and the amount of light passing through the blue pixel B. In other words, in the current frame, the amount of light passing through the red pixel R is larger than the amount of light passing through the green pixel G, and the blue pixel B. Accordingly, the red light emitted through the red color filter of the red pixel R is larger in amount than the green light emitted through the green color filter of the green pixel G and the blue light emitted through the blue color filter of the blue pixel B.

As the light transmittance of the red pixel R is increased compared to the light transmittance of the green and blue pixels G and B by the selective overdriving, the loss of red light due to the long excitation time of the KSF red phosphor Rf may be compensated, which will be described in more detail below.

In other words, when the gray level of the red image data signal applied to the red pixel R increases from the first gray level to the second gray level, due to the long excitation time of the KSF red phosphor Rf, the amount of red light emitted from the light source 300 is less than the amount of each of green light and blue light emitted from the light source 300 in the current frame.

However, during the current frame, of the light generated from the light source 300, a small amount of the red light may be increased by using the red color filter of the red pixel R having a high transmittance. Accordingly, during the current frame, the amount of red light passing through the red pixel R may be substantially equal to the amount of the green light passing through the green pixel G and the amount of the blue light passing through the blue pixel B. In other words, during the current frame, the red light may reach the original target luminance value. Accordingly, the image may be normally displayed during the current frame.

FIG. 9B is a diagram for explaining the operation of the timing controller of FIG. 1 when the magnitude of the image data signal decreases, according to an exemplary embodiment of the present invention.

Each X-axis in FIG. 9B represents a frame (or time), and the Y-axis in FIG. 9B represents the magnitude of the image data signal (in other words, the grayscale of the image data signal).

As described above, the corrected image data signal Cd is a signal having a magnitude (e.g., a gray level) different from that of the red image data signal of the current frame. For example, when the red image data signal of the current frame has a value less than that of the red image data signal of the previous frame, the corrected image data signal Cd has a value less than that of the red image data signal of the current frame. In other words, when the red image data signal of the current frame has a value less than that of the red image data signal of the previous frame, the timing controller 801 selects, as the red image of the current frame, the corrected image data signal Cd that has a value less than that of the red image data signal of the current frame.

For example, as illustrated in FIG. 9B, when a red image data signal Rn (indicated by a dashed line) of the n-th frame Fn has a value less than that of a red image data signal Rn-1 of the (n-1)-th frame Fn-1, the timing controller 801 selects, as the red image of the n-th frame Fn, a corrected image data signal Cd that has a value less than that of the red image data signal Rn of the n-th frame Fn, instead of selecting the red image data signal Rn of the n-th frame Fn, and applies the corrected image data signal Cd to the data driver 811. In other words, as illustrated in FIG. 9B, the timing controller 801 outputs the corrected image data signal Cd instead of the red image data signal Rn of the n-th frame Fn as the red image of the n-th frame Fn.

In an exemplary embodiment of the present invention, after the corrected image data signal Cd is output, the timing controller 801 may select, as a red image of a succeeding frame, the red image data signal of the current frame or a red image data signal having a value substantially equal to that of the red image data signal of the current frame, and may apply the selected red image data signal to the data driver 811. For example, as illustrated in FIG. 9B, a red image data signal Rn+1 of the (n+1)-th frame Fn+1 provided from the timing controller 801 may have a value substantially equal to the value of the red image data signal of the n-th frame Fn.

In another exemplary embodiment of the present invention, the aforementioned correction image data signal Cd may be selected as the red image of the succeeding frame. In other words, the corrected image data signal Cd may be selected for a plurality of consecutive frames including the current frame. For example, the red image data signal Rn+1 of the (n+1)-th frame Fn+1 in FIG. 9B may have a value substantially equal to a value of the corrected image data signal Cd.

In this way, of the red, green, and blue image data signals, the timing controller 801 over-drives only the red image data signal in a selective manner. Accordingly, the red pixel R receiving the over-driven red image data signal may transmit less light than the gray level of the current frame.

For example, when the gray level of the red image data signal applied to the red pixel R decreases from the second gray level to the first gray level, the light transmittance of the red pixel R in the current frame becomes lower than the light transmittance of the first gray level.

Accordingly, when the red pixel R, the green pixel G and the blue pixel B all display the same gray scale image in the current frame, the amount of light passing through the red pixel R is reduced, as compared to the amount of light passing through the green pixel G and the amount of light passing through the blue pixel B. In other words, in the current frame, the light passing through the red pixel R is less than the amount of the light passing through the green pixel G, and the blue pixel B. Accordingly, the red light emitted through the red color filter of the red pixel R is less in amount than the green light emitted through the green color filter of the green pixel G and the blue light emitted through the blue color filter of the blue pixel B.

As the light transmittance of the red pixel R decreases as compared to the light transmittance of the green and blue pixels G and B by the selective overdriving, the excess light due to the long persistence time of the KSF red phosphor Rf may be compensated, which will be described in more detail below.

In other words, when the gray level of the red image data signal applied to the red pixel R decreases from the second gray level to the first gray level, due to the long persistence time of the KSF red phosphor Rf, the amount of red light emitted from the light source 300 is larger than the amount of each of green light and blue light emitted from the light source 300 in the current frame.

However, during the current frame, of the light generated from the light source 300, a large amount of the red light may be reduced by using the red color filter of the red pixel R having a low transmittance. Accordingly, during the current frame, the red light passing through the red pixel R may be substantially equal to the amount of the green light passing through the green pixel G and the amount of the blue light passing through the blue pixel B. In other words, during the current frame, the red light may reach the original target luminance value (e.g., the luminance of zero). Accordingly, the image may be normally displayed during the current frame.

In an exemplary embodiment of the present invention, when the red image data signal of the current frame and the red image data of the previous frame have the same value, the timing controller 801 selects the red image data signal of the current frame as the red image of the current frame, and applies the selected red image data signal of the current frame to the data driver 811.

The aforementioned corrected image data signal Cd may have a value that varies depending on the magnitude difference between the red image data signal of the current frame and the red image data signal of the previous frame. For example, when the red image data signal of the current frame is greater in magnitude than the red image data signal of the previous frame, the magnitude of the corrected image data signal Cd may increase as the difference (e.g., Δd in FIG. 9A) between the red image data signal of the current frame and the red image data signal of the previous frame increases. In addition, when the red image data signal of the current frame is less in magnitude than the red image data signal of the previous frame, the magnitude of the corrected image data signal Cd may decrease as the difference (e.g., Δd in FIG. 9B) between the red image data signal of the current frame and the red image data signal of the previous frame increases.

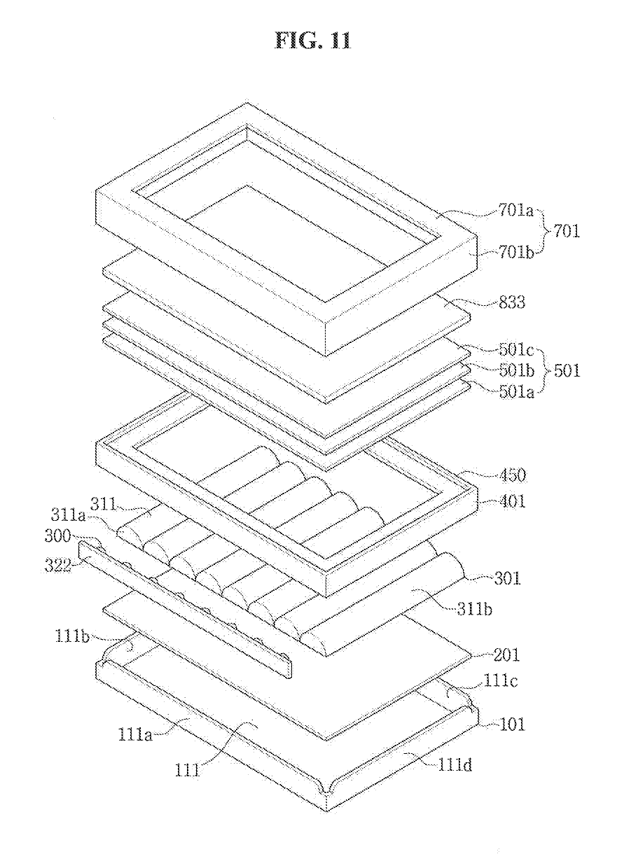

FIG. 10 is a diagram showing a look-up table and the timing controller of FIG. 1, according to an exemplary embodiment of the present invention.

The plurality of corrected image data signals 1040 may be stored in advance in a look-up table LUT. For example, difference values between the red image data signal of the current frame and the red image data signal of the previous frame and the corrected image data signals corresponding to the difference values may be stored in the lookup table LUT. The difference value may be the difference value of the positive polarity and the difference value of the negative polarity. In an exemplary embodiment of the present invention, when the red image data signal of the current frame is greater in magnitude than the red image data signal of the previous frame, the corrected image data signal corresponding to the difference value of the positive polarity may be selected, and when the red image data signal of the current frame is less than the red image data signal of the previous frame, the corrected image data signal corresponding to the difference value of the negative polarity may be selected.

The timing controller 801 may calculate the difference value between the red image data signal of the current frame and the red image data signal of the previous frame, and may select the corrected image data signal Cd corresponding to the difference value from the lookup table LUT as the red image of the current frame.

The magnitude of the corrected image data signal Cd may be determined based on the difference value 1010 between the red image data signal of the current frame and the red image data signal of the previous frame, the afterglow characteristic (or persistence time) 1020 of the red phosphor Rf, and the location of the display area 1030 in which the red pixel R is located.

In other words, the magnitude of the corrected image data signal Cd may vary depending on the persistence time of the red phosphor Rf and the location of the red pixel R in the display area.

For example, when a red image data signal of the current frame applied to a first red pixel and a red image data signal of the current frame applied to a second red pixel are the same as each other, the red image data signal of the previous frame applied to the first red pixel and the red image data signal of the previous frame applied to the second red pixel are the same as each other, the red phosphor Rf of the light source is the aforementioned KSF red phosphor Rf, and the first red pixel and the second red pixel are located in different display areas from each other, a corrected image data signal Cd applied to the first red pixel as the red image of the current frame and a corrected image data signal Cd applied to the second red pixel as the red image of the current frame may have different values.

Information on the persistence time of the red phosphor Rf described above and the location of the red pixel R in the display area may be stored in the lookup table LUT. In other words, the difference between the red image data signal of the current frame and the red image data signal of the previous frame, the persistence time of the red phosphor Rf, and the location of the red pixel R in the display area that determines the magnitude of the corrected image data signal Cd may be stored in advance, e.g., 1010, 1020 and 1030, in the look-up table LUT.

In an exemplary embodiment of the present invention, since the red phosphors Rf of all the light sources 300 provided in the backlight 857 include substantially the same material, the persistence time of the red phosphors Rf may not be separately stored in the lookup table LUT. For example, the persistence time of the ref phosphors Rf may be treated as a fixed constant. In an exemplary embodiment of the present invention, the persistence time of the red phosphor Rf may be reflected in advance to the magnitude of the corrected image data signal Cd.

The lookup table LUT may be embedded in the timing controller 801.

FIG. 11 is a configuration view illustrating a display device including a light guide plate of FIG. 6, according to an exemplary embodiment of the present invention.

The display device according to an exemplary embodiment of the present invention, as illustrated in FIG. 11, includes a bottom case 101, a reflective sheet 201, a light guide plate 301, an optical sheet 501, a light source 300, a printed circuit board 322, an intermediate frame 401, a display panel 833, and a top case 701.

Of the above constituent elements, the reflective sheet 201, the light guide plate 301, the optical sheet 501, the light source 300, the printed circuit board 322, the intermediate frame 401, the top case 701, and the bottom case 101 are included in the backlight 857.

The bottom case 101 has an accommodation space therein. The light source 300, the printed circuit board 322, the reflective sheet 201, the light guide plate 301, the optical sheet 501, and the intermediate frame 401 are disposed in the accommodation space of the bottom case 101.

To secure the accommodation space, the bottom case 101 may include a base portion 111 having, for example, a quadrangular shape, and first to fourth side portions 111a, 111b, 111c, and 111d respectively located at edges of the base portion 111. The space defined by the first to fourth side portions 111a, 111b, 111c, and 111d and the base portion 111 is the aforementioned accommodation space.

The first side portion 111a and the third side portion 111c have a length longer than a length of the second side portion 111b and the fourth side portion 111d.

The first to fourth side portions 111a to 111d have a shape protruding from their respective edges of the base portion 111 toward the top case 701 at a predetermined height. The first to fourth side portions 111a to 111d are fixed to the base portion 111. The first to fourth side portions 111a to 111d and the bottom case 101 may be integrally formed into a unitary structure.

The reflective sheet 201 is positioned on the base portion 111. For example, the reflective sheet 201 is positioned between the base portion 111 and the light guide plate 301. The reflective sheet 201 reflects light that has passed through a lower outer surface of the light guide plate 301 and propagates outwards to be directed toward the light guide plate 301 once again, thereby substantially minimizing light loss.

The reflective sheet 201 may include, for example, polyethylene terephthalate (“PET”), thus having reflective characteristics, and one surface of the reflective sheet 201 may be coated with a diffusion layer including, for example, titanium dioxide. In an exemplary embodiment of the present invention, the reflective sheet 201 may include a material including a metal such as silver (Ag).

The light guide plate 301 is positioned on the reflective sheet 201. For example, the light guide plate 301 is positioned between the reflective sheet 201 and the intermediate frame 401. The light guide plate 301 guides the light provided from the light source 300 to the display panel 833. In an exemplary embodiment of the present invention, the light guide plate 301 uniformly applies the light received from the light source 300 to the entire surface of the display portion of the display panel 833.

A plurality of scattering patterns may be further provided on the lower outer surface of the light guide plate 301 to improve the reflectance of the light guide plate 301. In an exemplary embodiment of the present invention, the interval between the scattering patterns increases, as a distance from the light incidence surface 311a of the light guide plate 301 increases. In an exemplary embodiment of the present invention, the lower outer surface of the light guide plate 301 may be a surface of the light guide plate 301 that faces the reflective sheet 201.

The light guide plate 301 may include a light transmitting material, such as polycarbonate (PC) and an acrylic resin, e.g., polymethylmethacrylate (PMMA), to allow light to be efficiently guided.

The optical sheet 501 diffuses and condenses the light transmitted from the light guide plate 301, and is positioned between the light guide plate 301 and the display panel 833. The optical sheet 501 may include a diffusion sheet 501a, a light condensing sheet 501b, and a protective sheet 501c. The diffusion sheet 501a, the light condensing sheet 501b, and the protective sheet 501c are sequentially stacked on the light guide plate 301.

The diffusion sheet 501a diffuses the light guided from the light guide plate 301 to prevent the light from being partially concentrated.

The light condensing sheet 501b is positioned on the diffusion sheet 501a, and condenses the light diffused from the diffusion sheet 501a in a direction perpendicular to the display panel 833. To accomplish this, triangular prisms may be arranged on a surface of the light condensing sheet 501b in a predetermined arrangement.

The protective sheet 501c is positioned on the light condensing sheet 501b to protect the surface of the light condensing sheet 501b and to diffuse light to make the light distribution uniform. The light having passed through the protective sheet 501c is provided to the display panel 833.

The intermediate frame 401 has the shape of a quadrangular frame (or a quadrangular ring) with its center portion open. The intermediate frame 401 is positioned on the light guide plate 301. The intermediate frame 401 may further include a protrusion 450. The protrusion 450 protrudes from an edge of the intermediate frame 401 toward the top case 701 to enclose the display panel 833.

The top case 701 has an opening for exposing the display portion of the display panel 833. In other words, the top case 701 has the shape of a quadrangular frame (or a quadrangular ring) with its center portion open. The top case 701 covers the edge of the display panel 833 and part of the first to fourth side portions 111a, 111b, 111c and 111d. To accomplish this, the top case 701 includes an upper cover 701a covering the edge of the display panel 833 and a side cover 701b covering part of the first to fourth side portions 111a, 111b, 111c and 111d.

The top case 701, the bottom case 801, and the intermediate frame 401 are coupled to each other by fastening means. To accomplish this, the top case 701 has a first fastening hole through the side cover 701b, the bottom case 801 has a second fastening hole through each of the side portions 111a, 111b, 111c and 111d, and the intermediate frame 401 has a fastening groove. The fastening means passes through the first fastening hole and the second fastening hole sequentially, and is fitted into the fastening groove.

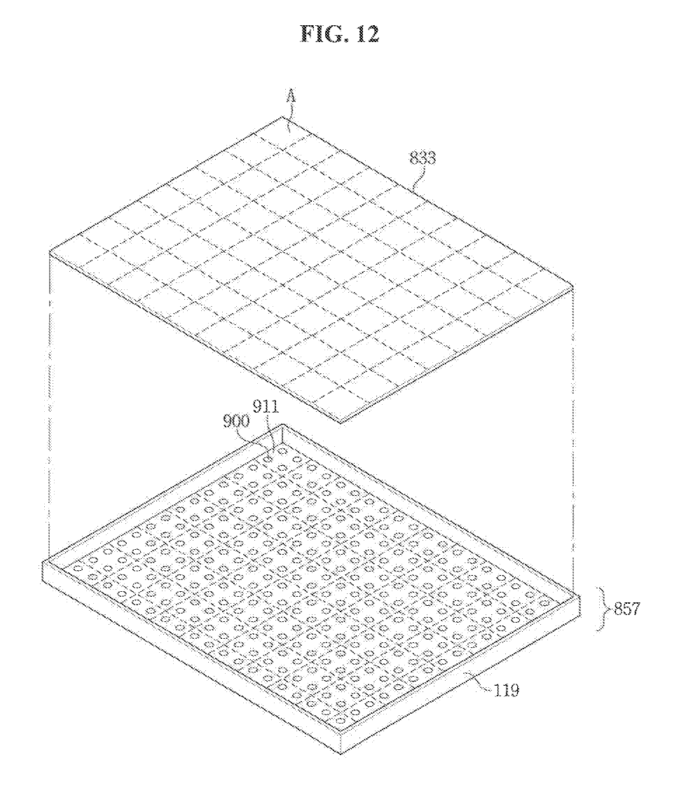

FIG. 12 is a perspective view illustrating a backlight and a display panel of FIG. 1 according to another exemplary embodiment of the present invention.

As illustrated in FIG. 12, a backlight 857 may include a plurality of light sources 900 and a bottom case 119.

The backlight 857 of FIG. 12 is a direct-type backlight.

A display panel 833 includes a plurality of display areas. For example, the display panel 833 has a display portion and a non-display portion surrounding the display portion, and the display portion may include the plurality of display areas A described above. The plurality of display areas A are located in the display portion of the display panel 833. The plurality of display areas A are arranged in a matrix form on the display panel 833.

The bottom case 119 may include a plurality of light source blocks 911. The light source blocks 911 are located to correspond to the display areas A of the display panel 833, respectively. In other words, the light source blocks 911 are each face a corresponding one of the display areas A. For example, FIG. 12 shows eighty light blocking blocks (e.g., first to eightieth light source blocks) and eighty display areas (e.g., first to eightieth display areas), and an m-th light source block faces an m-th display area, where m is a natural number from 1 to 80.

In FIG. 12, four light sources 900 are disposed per one light source block 911. However, the number of light sources 900 arranged per one light source block 911 is not limited thereto.

The light source 900 of FIG. 12 may have the same structure as the light source 300 of FIG. 3 described above.

Light sources positioned at different light guide blocks are connected to different power lines from each other. For example, when one of the light source blocks of FIG. 12 is a first light source block and another of the light source blocks other than the first light source block is a second light source block, light sources of the first light source block (hereinafter, “first light sources”) and light sources of the second light source block (hereinafter, “second light sources”) are connected to different power lines from each other. In other words, the first light sources may be connected to a first power line, and the second light sources may be connected to a second power line.

In an exemplary embodiment of the present invention, the light sources located in a same light source block are connected in common to a same power line. For example, the first light sources are connected in common to the first power line, and the second light sources are connected in common to the second power source line.

Since the light sources of different light source blocks are connected to different power lines from each other in such a manner, the light sources of different light source blocks may receive driving powers of different magnitudes through the power lines, respectively. Accordingly, the light sources of different light source blocks may emit light having different luminances from each other. Accordingly, it is possible to perform a local dimming operation in which the luminance of light may be controlled for each light guide block.

As set forth hereinabove, the display device according to one or more exemplary embodiments of the present invention may provide the following effects.

The light source of the display device includes KSF red phosphors favorable for wide color gamut. The display device over-drives only the red image data signals in a selective manner to compensate for the excitation and afterglow characteristics of the KSF red phosphor. Accordingly, the KSF red phosphor may be utilized and the degradation of the image quality may be substantially prevented.

While the present invention has been illustrated and described with reference to exemplary embodiments thereof, it will be apparent to those of ordinary skill in the art that various changes in form and detail may be made thereto without departing from the spirit and scope of the present invention as defined by the following claims.

What is claimed is:

1. A display device, comprising:
a display panel comprising a red pixel, a green pixel and a blue pixel;
a backlight unit providing light to the display panel;
a data driver connected to the display panel; and
a timing controller applying a red image data signal, a green image data signal, and a blue image data signal corresponding to the red pixel, the green pixel and the blue pixel, respectively, to the data driver,
wherein, when the red image data signal of a current frame has a magnitude different from a magnitude of the red image data signal of a previous frame, the timing controller applies a corrected image data signal having a magnitude different from the magnitude of the red image data signal of the current frame to the data driver as a red image of the current frame,
wherein, when the green image data signal of the current frame has a magnitude different from a magnitude of the green image data signal of the previous frame, the timing controller applies the green image data signal of the current frame to the data driver as a green image of the current frame, and
wherein, when the blue image data signal of the current frame has a magnitude different from a magnitude of the blue image data signal of the previous frame, the timing controller applies the blue image data signal of the current frame to the data driver as a blue image of the current frame.

2. The display device of claim 1, wherein, when the magnitude of the red image data signal of the current frame is greater than the magnitude of the red image data signal of the previous frame, the magnitude of the corrected image data signal is greater than the magnitude of the red image data signal of the current frame.

3. The display device of claim 1, wherein, when the magnitude of the red image data signal of the current frame is less than the magnitude of the red image data signal of the previous frame, the magnitude of the corrected image data signal is less than the magnitude of the red image data signal of the current frame.

4. The display device of claim 1, wherein the backlight unit comprises:
a light source emitting the light; and
a bottom case at which the light source is positioned.

5. The display device of claim 4, wherein the light source comprises:
a light emitting chip emitting blue light; and
red phosphors and green phosphors positioned on the light emitting chip.

6. The display device of claim 5, wherein the red phosphor has a persistence time longer than a persistence time of the green phosphor.

7. The display device of claim 5, wherein the red phosphor has an excitation time longer than an excitation time of the green phosphor.

8. The display device of claim 5, wherein the red phosphor comprises K₂SiF₆:Mn₄⁺.

9. The display device of claim 5, wherein the magnitude of the corrected image data signal is determined based on:
a magnitude difference between the red image data signal of the current frame and the red image data signal of the previous frame;
a persistence time of the red phosphor; or
a location of a display area of the display panel in which the red pixel is located.

10. The display device of claim 9, further comprising a look-up table in which the magnitude difference between the red image data signal of the current frame and the red image data signal of the previous frame, the persistence time of the red phosphor, and the location of the display area in which the red pixel is located are stored.

11. The display device of claim 5, wherein the backlight unit comprises:
a plurality of light sources comprising the light source; and
a light guide plate having a plurality of light incidence surfaces facing the plurality of light sources, and a plurality of light emitting surfaces facing a plurality of display areas of the display panel.

12. The display device of claim 11, wherein the light guide plate comprises a plurality of light guide blocks, and each light guide block has one of the plurality of light incidence surfaces and one of the plurality of light emitting surfaces.

13. The display device of claim 12, wherein at least one of the light guide blocks has a semicircular column shape.

14. The display device of claim 5, wherein the backlight unit further comprises a plurality of light sources comprising the light source, wherein the bottom case has a plurality of light source areas facing a plurality of display areas of the display panel, and wherein the plurality of light sources are located in the plurality of light source areas of the bottom case.

15. The display device of claim 1, wherein the timing controller applies the corrected image data signal to the data driver during the current frame or a plurality of consecutive frames comprising the current frame.

16. A method of driving a display device that includes a display panel, a backlight unit, a data driver and a timing controller, the display panel including a red pixel, a green pixel and a blue pixel, the method comprising:
providing, via the backlight unit, light to the display panel;
applying, via the timing controller, a red image data signal, a green image data signal, and a blue image data signal corresponding to the red pixel, the green pixel and the blue pixel, respectively, to the data driver;
applying a corrected image data signal having a magnitude different from the magnitude of the red image data signal of a current frame to the data driver as a red image of the current frame, when the red image data signal of the current frame has a magnitude different from a magnitude of the red image data signal of a previous frame;
applying the green image data signal of the current frame to the data driver as a green image of the current frame, when the green image data signal of the current frame has a magnitude different from a magnitude of the green image data signal of the previous frame; and
applying the blue image data signal of the current frame to the data driver as a blue image of the current frame, when the blue image data signal of the current frame has a magnitude different from a magnitude of the blue image data signal of the previous frame.

17. The method of claim 16, wherein, when the magnitude of the red image data signal of the current frame is greater than the magnitude of the red image data signal of the previous frame, the magnitude of the corrected image data signal is greater than the magnitude of the red image data signal of the current frame, and
when the magnitude of the red image data signal of the current frame is less than the magnitude of the red image data signal of the previous frame, the magnitude of the corrected image data signal is less than the magnitude of the red image data signal of the current frame.

18. The method of claim 16, wherein a light source of the backlight unit comprises: a light emitting chip emitting blue light; and red phosphors and green phosphors positioned on the light emitting chip, and
wherein the red phosphor has a persistence time longer than a persistence time of the green phosphor and has an excitation time longer than an excitation time of the green phosphor.

19. The method of claim 18, wherein the red phosphor comprises K₂SiF₆:Mn₄⁺.

20. The method of claim 18, wherein the magnitude of the corrected image data signal is determined based on:
a magnitude difference between the red image data signal of the current frame and the red image data signal of the previous frame;
a persistence time of the red phosphor; or
a location of a display area of the display panel in which the red pixel is located.

21. A display device, comprising:
a display panel comprising a first pixel and a second pixel;
a backlight unit providing light to the display panel;
a data driver connected to the display panel; and
a timing controller applying a first image data signal and a second image data signal corresponding to the first pixel and the second pixel, respectively, to the data driver,
wherein, when the first image data signal of a current frame has a magnitude different from a magnitude of the first image data signal of a previous frame, the timing controller applies a corrected image data signal having a magnitude different from the magnitude of the first image data signal of the current frame to the data driver as a first image of the current frame, and
when the second image data signal of the current frame has a magnitude different from a magnitude of the second image data signal of the previous frame, the timing controller applies the second image data signal of the current frame to the data driver as a second image of the current frame.

22. The display device of claim 21, wherein the first pixel is a red pixel and the second pixel is a green pixel or a blue pixel.

23. The display device of claim 21, wherein the first image data signal is a red image data signal and the second image data signal is a green image data signal or a blue image data signal.

24. The display device of claim 21, wherein the first image is a red image and the second image is a green image or a blue image.
